(19) United States
(12) Patent Application Publication
(10) Pub. No.: US 2004/0051298 A1
(43) Pub. Date: Mar. 18, 2004

(54) Method for authenticating correspondence between primary and secondary packages of a product

(76) Inventors: Pierre Corbobesse, Boussy Saint-Antoine (FR); Claude Trapletti, Tregueux (FR)

Correspondence Address: JACOBSON HOLMAN PLLC, 400 SEVENTH STREET N.W., SUITE 600, WASHINGTON, DC, 20004, US

(21) Appl. No.: 10/415,664

(22) PCT Filed: Nov. 8, 2001
(86) PCT No.: PCT/FR01/03466

(30) Foreign Application Priority Data
Nov. 8, 2000 (FR) 00/14308

(51) Int. Cl. B42D 15/00

(52) U.S. Cl. 283/67

(57) ABSTRACT

The primary package for containing the product is provided with a label carrying or constituting the trademark of the product, while the secondary package for containing the primary package includes a “main” coded mark (5) enabling it to be identified at the time of sale. In accordance with the invention, another mark referred to as an “auxiliary” mark is applied to said label for the purpose of individualizing the product contained in the primary package, this auxiliary mark, which corresponds to another code (6), being written in very small characters that are not naturally readable but that can be read by means of a reader device specially adapted for this purpose, the codes (5, 6) being related by a one-to-one relationship, and being input into a computer database (8) on the packaging line itself so that by comparing the marks it is possible to verify whether the two packages do indeed correspond. The method makes it possible to control and monitor the path followed by a product, in particular a luxury product, from its packaging site to its point of sale.

The present invention relates to a method of authenticating correspondence between primary and secondary packages of a product. The term “primary package” is used to mean the package for receiving and containing the product. By way of example, this package may be constituted by a flask or a bottle if the product is a liquid.

The secondary package is an “outer package” for receiving and containing the primary package, naturally together with the product contained therein.

The invention has been devised specifically in association with the packaging of cosmetics, and more particularly of top-of-range perfumes.

In this application, the primary package is thus a flask while the secondary package is a box, e.g. a cardboard box.

The manufacturers of perfumes, and in particular luxury perfumes, seek to be able to control and monitor completely the traceability of their products and their distribution channels, as from being placed on the market.

Thus, a French manufacturer producing a given perfume intended for an authorized Asiatic outlet will seek to be sure that the product does indeed reach the outlet. It is important to be able to verify qualitative traceability of the product in effective manner.

Unfortunately, this verified mode of distribution is put into doubt by unscrupulous and greedy people who make use of parallel distribution channels.

In order to mitigate that drawback, it is common practice for perfume manufacturers to place a code on the secondary packaging of the product, for example an optically readable code such as a bar code, said code characterizing the origin, the nature, and the destination of the product.

In principle, on reading the code on the premises here the product is sold, it should be possible to determine whether the product has followed normal distribution channels or whether it has followed “parallel” channels. Nevertheless, in order to avoid this possibility of inspection, fraudulent operators are in the habit of disguising, reproducing, or altering the code in such a manner as to prevent such verification. Once the code is unreadable, or if it is counterfeit, it is no longer possible to determine whether the product has followed normal distribution channels.

In practice, this matters little to the final consumer insofar as the disguise and/or damage apply only to the secondary package, which package can be disposed of without trouble after purchase; what is of interest to the consumer is to have a primary package (flask) in proper condition so as to guarantee that the product is authentic.

The fraud cannot be proved from the primary package only.

The present invention seeks to solve this problem, making it possible at any time to monitor proper correspondence between the primary package and the secondary package, as is desired by the manufacturer.

The method of the present invention is a method of authenticating correspondence between primary and secondary packages of a product, the primary package which is for containing the product being provided with a label, while the secondary package which is for containing the primary package includes a “main” coded mark which enables it to be identified when the product is sold. The label carries a certain amount of information, in particular the trademark of the product; it is fixed in the usual manner on the primary package.

In accordance with the invention, another mark, known as an “auxiliary” mark, is applied to said label for the purpose of individualizing the product contained in the primary package, said auxiliary mark comprising an auxiliary code written in very small characters, that is not naturally readable, but that is readable by means of a reader device specifically adapted to this purpose. The two corresponding codes (the main code and the auxiliary code) are input into a computer database in a manner that is entirely random at the time the two packages come together in the packaging station, where a given primary package is inserted and placed inside a given secondary package, these two codes being related to each other in the computer database (by a one-to-one relationship), in such a manner that reading one of the two codes of a matching pair of packages enables the other code to be determined by interrogating the computer database (and vice versa), and a comparison between these two marks making it possible to verify that the two packages do indeed correspond.

By means of this arrangement, if the product has been distributed via a parallel channel, the fraudulent person is obliged not only to damage the mark which appears on the secondary package (the box), but also the mark which appears on the label of the primary package (the flask), which, as a general rule, the purchaser is not prepared to accept on a luxury product whose presentation must be perfect in order to guarantee that it is authentic.

Because the auxiliary mark and code are written in characters that are very small, they do not interfere with the good appearance of the label.

The label carries the trademark of the product, or possibly even constitutes the trademark proper (for a semi-device mark that is a representation of the label in question).

In the event of unauthorized damage or removal of said mark (by scratching, rubbing out, or masking, for example), then the trademark has been attacked and this can be considered as constituting an act of infringement, which can lead to legal penalties.

The potential avenues open to fraud are thus considerably restricted.

Furthermore, according to various advantageous but non-limiting characteristics of the invention:

the main mark is an optically or electronically readable code, such as a bar code, for example;

the auxiliary mark comprises a code, e.g. an alphanumeric code, placed on the label by microprinting; and

the alphanumeric code is integrated within a masking area which is transparent to infrared radiation.

The invention also provides product packaging comprising both a primary package having a label, and intended to contain the product, and a secondary package for containing the primary package, the packaging being remarkable in that said packages carry respectively an auxiliary mark and a main mark which enable an authentication method as described above to be implemented.

Other characteristics and advantages of the invention appear from the description given below with reference to the accompanying drawings which show one possible implementation.

In the drawings:

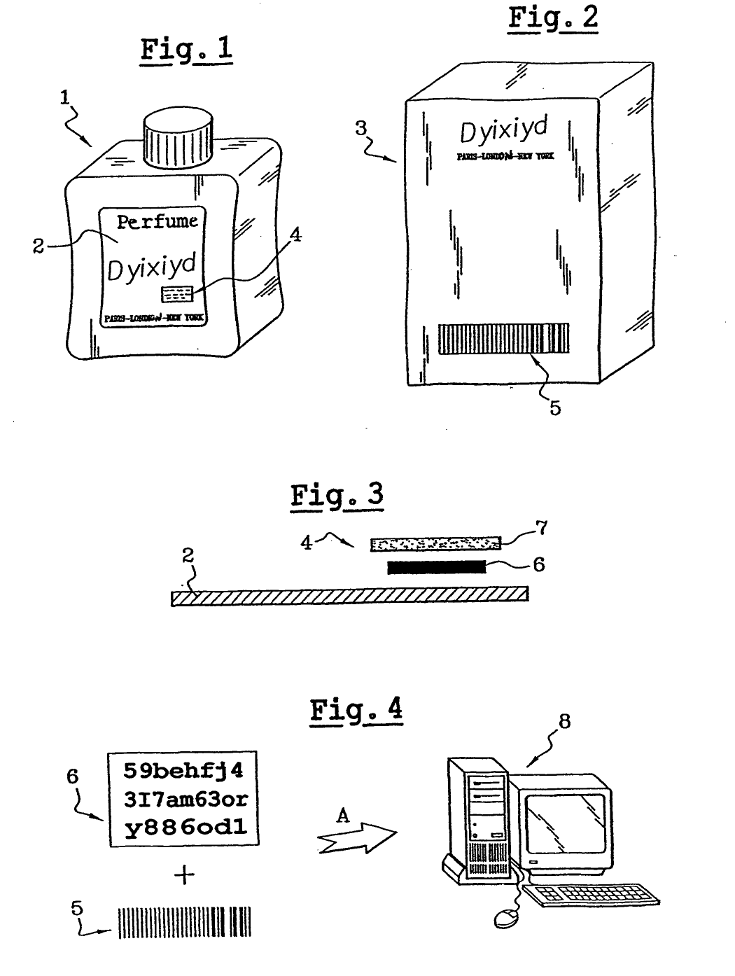

FIGS. 1 and 2 are diagrammatic perspective views showing respectively a perfume flask and a box for receiving and containing said flask;

FIG. 3 is a diagram for showing how the auxiliary mark is printed and masked on the label of the flask;

FIG. 4 is a diagram for showing how the correlation between the main and auxiliary marks is input into the computer;

FIG. 5 is a diagram for showing how the auxiliary mark is masked;

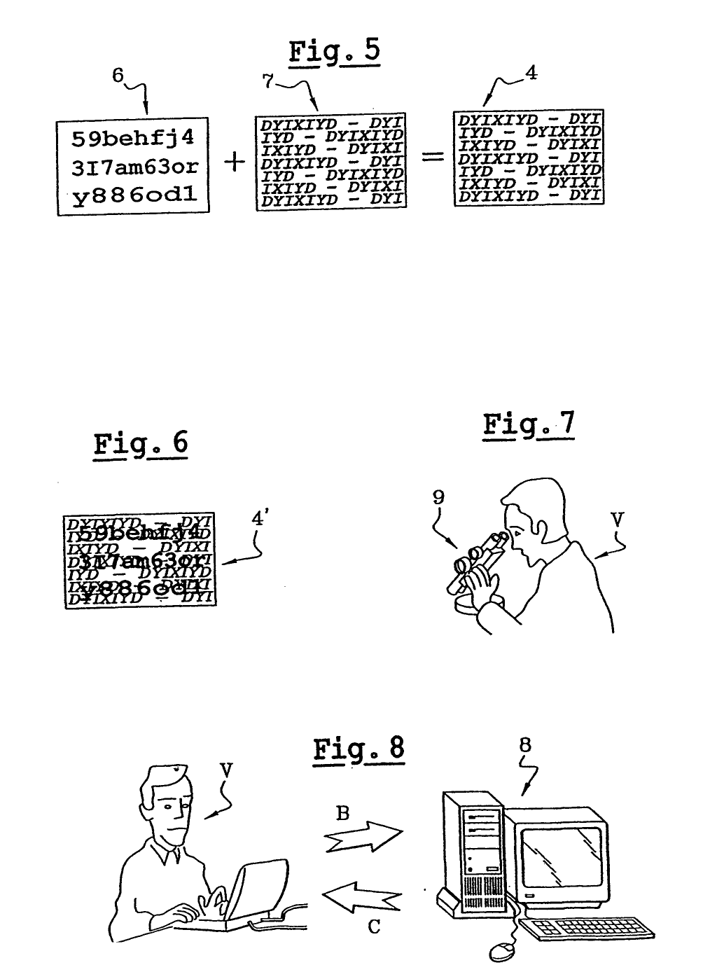

FIG. 6 shows the auxiliary mark being revealed;

FIG. 7 shows a person verifying authenticity decoding the auxiliary mark by means of an appropriate reader device; and

FIG. 8 shows the same person verifying the correlation between the two marks that appear on the packaging of the product.

The flask 1 shown in FIG. 1 is a flask containing perfume, and a label 2 is fixed thereon in the usual manner, said label carrying a certain amount of information, and in particular the trademark of the perfume, which in the example shown is the fictitious trademark “Dyixiyd”

The secondary package 3 is a cardboard box in the form of a rectangular parallelepiped of dimensions suitable for receiving, containing, and protecting the flask 1. It also carries a certain amount of information, including the trademark “Dyixiyd”.

According to an essential characteristic of the invention, the flask 1 and the box 3 carry respective marks 4 and 5.

As will readily be understood, merely by observing FIGS. 3 and 4, the mark 4 is made up of two superposed marks 6 and 7 applied to the label 2.

It should be observed that the mark 4 is applied to the usual label 2 which carries or constitutes the trademark of the product contained in the flask 1. It is not a mark applied to some additionally-applied label.

The mark 4, and correspondingly the marks 6 and 7 which make it up, is of small dimensions, being almost imperceptible, so as to ensure that the overall visual appearance of the label 2 is spoiled very little, if at all.

The mark 6 is an alphanumeric code, comprising an arbitrary string of digits and letters. This mark is written in very small characters making it impossible or almost impossible to read with the naked eye, but capable of being read by means of a magnifying glass or a monocular or binocular microscope. In other words this is done by microprinting on the label 2 using ordinary ink, e.g. black ink.

The mark 7 is a printed area comprising, for example, a background containing a pattern. In the example shown, this pattern is made up of a succession of the letters D, Y, I, X, I, Y, and D, recalling the trademark and forming a repeating pattern.

This area 7 is dimensioned and positioned in such a manner as to cover the alphanumeric code 6 completely.

This covering completely masks the code 6, which in this case is completely illegible and unintelligible under normal light.

Nevertheless, the ink used for making the background of the area 7 and its pattern (the letters D, Y, I, X, I, Y, and D) are such as to be transparent under infrared light.

The bar code 5 which is applied to the box 3 contains a certain amount of information in encoded form; this information relates in particular to the nature, the quality, and the trademark of the perfume; it also contains the place (country) of sale of the product, together with the identity of the vendor, wholesaler, or retailer, duly authorized to make the sale, for example.

The auxiliary code 6 corresponds to an “expert” level of code (special reader, accredited personnel to perform reading, etc.), while the main code 5 has a general function of monitoring traceability.

The code 6 is generated in full or in part in a manner that is completely arbitrary and random.

The main code 5 and the auxiliary mark 4 are applied respectively to the secondary package 3 and to the label 2 upstream from the packaging station in which each flask 1 “meets” the cardboard box 3 that is to receive it.

When two packages meet in the packaging station, where a given primary package is inserted and installed inside a given secondary package, the two corresponding codes 6 and 5 are input into a computer database.

These two codes 5 and 6 are thus associated with each other in one-to-one manner without any relationship between them being perceptible to an unauthorized person since the relationship is arbitrary (unlike a relationship resulting from implementing an algorithm that might be reconstituted, for example).

In a one-to-one relationship, a given auxiliary code 6 corresponds to one and only one main code 5, and vice versa.

On reading one of the two codes (5 or 6) on the two packages (1, 3) of a pair, it is possible to discover the other code (6 or 5) by interrogating the computer database.

A correlation is thus established on the production line itself by inputting both of the codes 5 and 6 into a computer, these codes being stored in a computer database referenced 8 in FIG. 4; arrow A represents the transmission of this data (i.e. the pair 5 and 6) to the equipment for inputting, storing, and processing the computer database 8. This equipment is provided with analysis software making it possible to determine whether the correlation associating the two given codes 5 and 6 is indeed complied with when a pair of codes is submitted thereto to verify whether they match.

FIG. 7 shows an operation of reading the auxiliary code 4 that is to be found on a flask that is to be sold, which flask was contained in a box 3.

This verification can be performed on the sales premises, for example inside a shop, by an inspector V.

The inspector has a suitable reader device 9; by way of example it could be constituted by a binocular microscope suitable for reading in the infrared.

This device enables the inspector V performing this task to read the mask code 6 through the mask 7 since the mask is transparent to infrared radiation, thus enabling the inspector to read the inscription which is marked 4′ in FIG. 6; the underlying alphanumeric code 6 is thus revealed.

As shown in FIG. 8, the code can then be keyed into a microcomputer.

In parallel, using an ordinary optical reader device, the bar code 5 on the box 3 containing the flask can also be read.

These two pieces of information are sent remotely, e.g. over the Internet, to the computer input and storage equipment 8 (arrow B in FIG. 8). The data is then processed by the computer system which seeks to discover whether the correlation initially established between the codes 5 and 6 is indeed to be found on the codes that have been submitted thereto.

The result of this analysis is sent to the inspector V by return (arrow C).

The inspector is thus informed as to the match, or on the contrary the mismatch, between the two packages, and the inspector can also verify whether the channels followed by the product from its manufacturing and packaging site (e.g. situated in France) to its point of sale (e.g. situated in an Asiatic country) is normal or otherwise.

Concerning the coding and subsequent deciphering of the auxiliary code on the primary package, using infrared radiation, known systems other that described above could be implemented.

For example it is possible to use a mark constituted by a strip of dark color, e.g. black, printed in the vicinity of one of the sides of the label.

To the naked eye, the strip would appear uniform from one end to the other.

In fact, it is made up of a set of segments in the form of rectangular zones positioned end to end; the differing zones are made out of inks having the same appearance in terms of color and shade under natural light, but of differing transparencies when exposed to infrared radiation.

For example, fixed categories of ink may be provided, all of identical color (black), but of degrees of transparency to infrared radiation that vary progressively.

Thus, for the ink that is the most permeable to infrared radiation, it is completely transparent when the zone in question is read by a camera suitable for reading in the infrared.

At the other end of the scale, the ink that is least permeable to infrared radiation remains black during such reading.

On being read, the other four categories of ink have varying shades of darkness (gray scale), going from black to transparent.

Thus, when read by an infrared camera, the strip reveals a set of segments having different shades.

It will thus be understood that it is possible to obtain a large number of different combinations for the configuration of the strip by acting on the number of segments and on the categories of ink used, and also by acting on their disposition.

The arrangement of such segments is easily transformed into a code, e.g. a digital code.

Furthermore, other known types of code means can be used, providing they are naturally illegible, and providing relatively sophisticated equipment is needed in order to reveal them, of a kind that is not easily obtained commercially nor easy to reconstruct.

In this respect, radar detection constitutes a technology that can be transposed to this case. The mark constituting the code can be made using an ink that contains metal particles that are detectable at low frequency, with the code being a function of the manner (in terms of distribution and density) in which the mass of particles is configured.

Although the above description is restricted to one very specific application, i.e. packaging perfume, the method of the invention naturally covers a vast field of applications. It can be implemented with packaging for a wide variety of products, whenever there is dual packaging, containing a product that is optionally liquid, and in particular a luxury product, where the supplier seeks to be able to control and monitor distribution channels from the packaging site to the point of sale.

1/ A method of authenticating correspondence between primary and secondary packages of a product, a primary package (1), which is for containing the product, a label (2) carrying a certain amount of information, and in particular the trademark of the product, being fixed in the usual manner to said primary package (1), and a secondary package (3), which is to contain the primary package (1), including a coded mark (5) referred to as a “main” mark, enabling it to be identified at the time the product is sold, the method being characterized by the fact that another mark (4) is applied to said label (2), said other mark being referred to as an “auxiliary” mark serving to individualize the product contained in the primary package, said auxiliary mark comprising an auxiliary code (6) written in very small characters that are not naturally readable, but that can be read by means of a reader device (9) specially adapted for this purpose, the two corresponding codes (5, 6) being input into a computer database (8) at the time the two packages (1, 3) meet each other in the packaging station where a given primary package (1) is inserted and placed inside a given secondary package (3), these two codes (5, 6) being related to each other in the computer database (8) by a one-to-one relationship in such a manner that reading one of the two codes (5 or 6) of the two packages making a pair makes it possible to discover the other code (6 or 5) by interrogating the computer database (8), and comparison between the two marks (5, 4) making it possible to verify that the two packages (1, 3) do indeed correspond.

2/ A method according to claim 1, characterized by the fact that said main mark (5) is an optically or electronically readable code, such as a bar code, for example.

3/ A method according to claim 1 or claim 2, characterized by the fact that said auxiliary mark (4) comprises a code (6), e.g. an alphanumeric code, placed on the label (2) by microprinting.

4/ A method according to claim 4, characterized by the fact that said code (6) is integrated within a masking area (7) which is transparent to infrared radiation.

5/ Product packaging comprising both a primary package (1) provided with a label (2) and serving to contain the product, and a secondary package (3) for containing the primary package (1), the packaging being characterized by the fact that the primary and secondary packages carry respective auxiliary and main marks (4, 5) suitable for implementing an authentication method in accordance with at least one of the preceding claims.
